(19) United States
(12) Patent Application Publication
(10) Pub. No.: US 2010/0320038 A1
(43) Pub. Date: Dec. 23, 2010

(54) OPPOSED-PISTON CALIPER BODY

(75) Inventors: Norihiko HAYASHI, Utsunomiya-shi (JP); Akihiko KOIKE, Sakura-shi (JP); Hiroo KAWAKAMI, Utsunomiya-shi (JP)

Correspondence Address: CARRIER BLACKMAN AND ASSOCIATES, 43440 WEST TEN MILE ROAD, EATON CENTER, NOVI, MI, 48375, US

(73) Assignee: HONDA MOTOR CO., LTD., TOKYO (JP)

(21) Appl. No.: 12/796,813

(22) Filed: Jun. 9, 2010

(30) Foreign Application Priority Data
Jun. 23, 2009 (JP) 2009-148729

(51) Int. Cl. F16D 55/226

(52) U.S. Cl. 188/72.4

(57) ABSTRACT

An opposed-piston caliper body includes a pair of acting portions adapted to be disposed one on each side of a disc rotor. Each of the acting portions has at least one cylinder bore defined therein, and a piston slidably inserted in the at least one cylinder bore. A bridge interconnects the acting portions. The cylinder bores defined in the acting portions are disposed out of axial alignment with each other. One of the acting portions has through holes defined therein in confronting relation to the cylinder bores defined in the other of the acting portions.

### CROSS-REFERENCE TO RELATED APPLICATION

This application is based upon and claims the benefit of priority from Japanese Patent Application No. 2009-148729 filed on Jun. 23, 2009, of which the contents are incorporated herein by reference.

### BACKGROUND OF THE INVENTION

1. Field of the Invention:

The present invention relates to an opposed-piston caliper body including a pair of acting portions disposed one on each side of a disc rotor, and having respective cylinder bores for pistons inserted in the acting portions.

2. Description of the Related Art:

Motor vehicles, such as four-wheeled motor vehicles, incorporate a disc brake device having a brake caliper, which comprises a mechanism for gripping a disc rotor that rotates a wheel with brake pads pressed by a hydraulic piston mounted in a caliper body. The brake caliper has a pair of acting portions interconnected by a bridge. The acting portions are disposed one on each side of the disc rotor. The brake pads are pressed against the disc rotor by the hydraulic piston, which is disposed in a cylinder bore defined in one of the acting portions.

One general type of brake caliper, which is known as a floating-type (collet type) brake caliper, has a hydraulic piston disposed in only one of the acting portions. During operation thereof, the other acting portion is pulled toward the disc rotor under reactive forces exerted when the hydraulic piston is actuated. Another brake caliper type that has been used in the art is an opposed-piston brake caliper, which includes hydraulic pistons disposed respectively in each of the acting portions.

Japanese Patent No. 2861217 discloses an opposed-piston disc brake having a caliper body including two separate caliper body members coupled to each other by bolts, and two pistons juxtaposed in each of the acting portions of the coupled caliper body members.

The opposed-piston disc brake disclosed in Japanese Patent No. 2861217 is made up of a relatively large number of parts, because the two body members must be coupled to each other by bolts. In addition, the disclosed opposed-piston disc brake cannot be assembled easily because, after the two body members have been coupled to each other by bolts, the four pistons need to be inserted into respective cylinder bores defined in the acting portions from gaps where brake pads are to be placed. Furthermore, when cylinder bores are formed in the caliper body members, a general floating-type of cutting machine and jig cannot be used directly, because the caliper body is constructed from the two caliper body members. Therefore, the process of forming cylinder bores in the caliper body members is low in efficiency.

### SUMMARY OF THE INVENTION

An object of the present invention is to provide an opposed-piston caliper body, which is made up of a reduced number of parts, and which can be manufactured with increased efficiency.

An opposed-piston caliper body according to the present invention includes a pair of acting portions adapted to be disposed one on each side of a disc rotor. Each of the acting portions has at least one cylinder bore defined therein, and a piston slidably inserted in the at least one cylinder bore. A bridge interconnects the acting portions. The cylinder bores defined in the acting portions are disposed out of axial alignment with each other, and one of the acting portions has a through hole defined therein in confronting relation to the cylinder bore defined in another of the acting portions.

More specifically, the cylinder bores defined in the acting portions are disposed out of axial alignment with each other, and the acting portions have through holes defined therein in confronting relation to the cylinder bores defined in the acting portions. When the opposed-piston caliper body is produced by casting, for example, dies for casting the acting portions with the cylinder bores may be positioned such that the through holes also will be formed by the dies. Therefore, the caliper body does not need to be made of two separate body members, whereby the number of parts required to make up the caliper body can be reduced. Further, it is not necessary to carry out a process of joining the separate body members, thus resulting in increased efficiency when manufacturing the caliper body. Furthermore, since the cylinder bores can easily be cut via the through holes, and the pistons can easily be inserted into the cylinder bores via the through holes, efficiency is increased upon cutting the cylinder bores and during assembly of the caliper body.

Numbers of the cylinder bores defined in the acting portions may be different from each other, and the total cross-sectional area of the at least one cylinder bore defined in one of the acting portions may be identical to the total cross-sectional area of the at least one cylinder bore defined in the other of the acting portions. With such an arrangement, the caliper body allows brake pads to be pressed in a balanced manner by the pistons, thereby improving the braking capability.

The opposed-piston caliper body may further include a fluid-pressure pipe, which holds the cylinder bores in fluid communication with each other, and which is embedded integrally in the acting portions and the bridge when the acting portions and the bridge are cast. Inasmuch as the fluid-pressure pipe is embedded integrally in the acting portions and the bridge, a fluid-pressure passage does not need to be formed in the caliper body after the caliper body is formed. As a result, manufacturing efficiency of the caliper body is increased. In addition, since joints in a fluid-pressure passage are unnecessary in light of the fact that the caliper body is not made up of two separate body members, but rather is formed integrally, fluid leakage from the fluid-pressure pipe can be minimized.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a brake caliper, which incorporates therein an opposed-piston caliper body according to an embodiment of the present invention;

FIG. 2 is an exploded perspective view of the brake caliper shown in FIG. 1;

FIG. 3 is a perspective view of a hydraulic pressure system of the brake caliper shown in FIG. 1;

FIG. 4 is a cross-sectional view showing, by way of example, a process of manufacturing the opposed-piston caliper body shown in FIG. 1; and

FIG. 5 is a fragmentary elevational view, partially in cross section, showing motor vehicle suspension components combined with the brake caliper, which incorporates therein the opposed-piston caliper body shown in FIG. 1.

### DESCRIPTION OF THE PREFERRED EMBODIMENTS

An opposed-piston caliper body according to an embodiment of the present invention in relation to a brake caliper, which incorporates therein the opposed-piston caliper body, will be described in detail below with reference to the accompanying drawings.

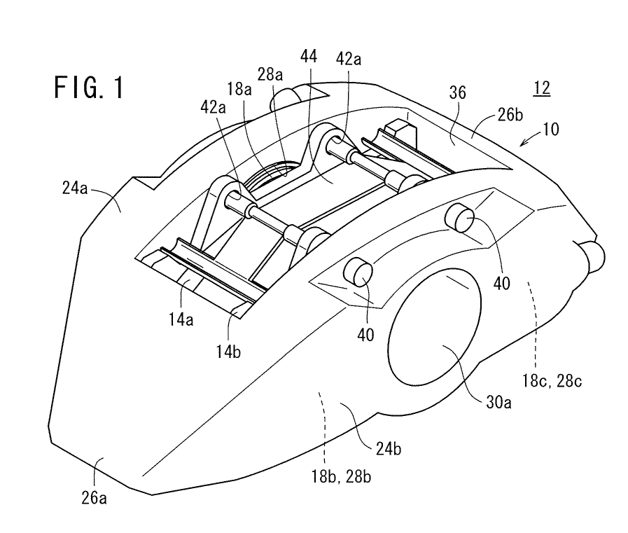

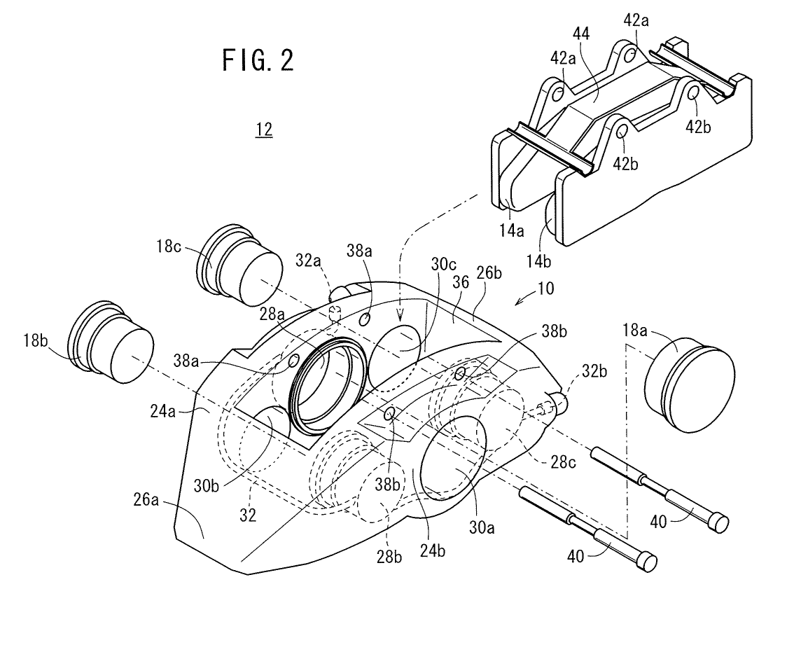

As shown in FIGS. 1 and 2, a brake caliper 12, which is a mechanism for gripping and braking a disk rotor that rotates together with a wheel of a motor vehicle such as an automobile or the like, includes an opposed-piston caliper body 10 (hereinafter also referred to as a “caliper body 10”), a pair of brake pads 14a, 14b disposed in the caliper body 10, and a plurality of (three in the present embodiment) pistons 18a, 18b, 18c for pressing the brake pads 14a, 14b against a disc rotor 16 (see FIG. 15).

The caliper body 10 includes a pair of acting portions 24a, 24b disposed one on each side of the disc rotor 16, and a pair of bridges 26a, 26b that interconnect the longitudinal ends of the acting portions 24a, 24b. The acting portions 24a, 24b and the bridges 26a, 26b are integrally formed by casting, for example.

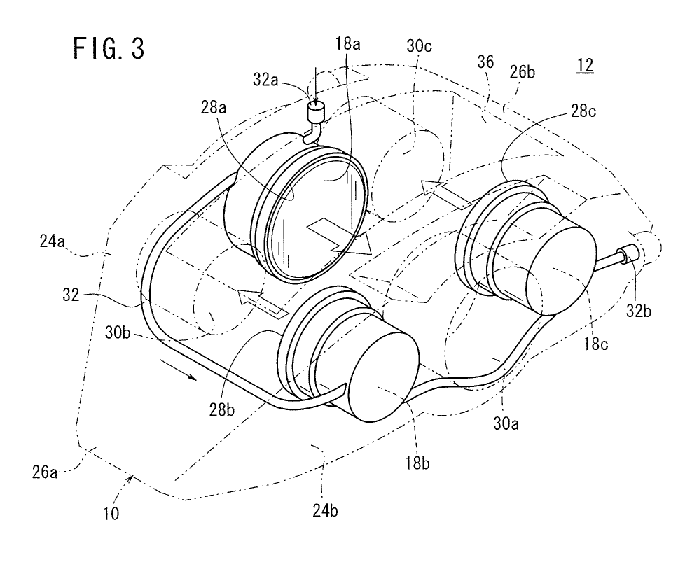

As shown in FIGS. 2 and 3, the piston 18a that is disposed in the acting portion 24a is larger in diameter than the pistons 18b, 18c that are disposed in the other acting portion 24b. The acting portion 24a has a larger-diameter cylinder bore 28a defined therein, with the piston 18a being axially slidably disposed therein. The acting portion 24b has two smaller-diameter cylinder bores 28b, 28c, with the pistons 18b, 18c being axially slidably disposed therein.

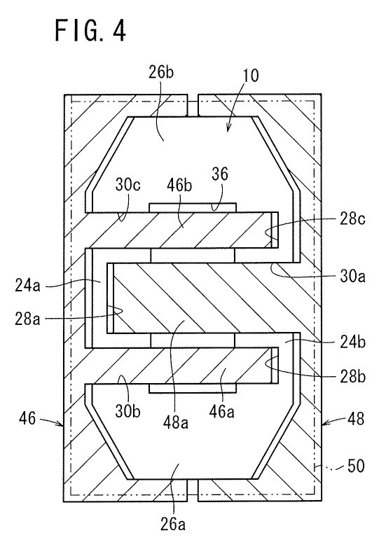

The cylinder bores 28a, 28b, 28c are positioned such that axes thereof are not aligned with each other along the direction in which the acting portions 24a, 24b confront each other (see also FIG. 4). The acting portions 24a, 24b also have through holes 30a, 30b, 30c defined therein, disposed respectively in confronting relation to the cylinder bores 28a, 28b, 28c. The through holes 30a, 30b, 30c are identical in diameter to or slightly larger in diameter than the cylinder bores 28a, 28b, 28c. More specifically, the through hole 30a, which is larger in diameter than the through holes 30b, 30c, is defined in the acting portion 24b in coaxial alignment with the cylinder bore 28a, whereas the through holes 30b, 30c are defined in the acting portion 24a in coaxial alignment with the respective cylinder bores 28b, 28c.

As shown in FIG. 3, a fluid-pressure pipe 32 is held in fluid communication with the cylinder bores 28a, 28b, 28c. The fluid-pressure pipe 32 is embedded integrally in the acting portions 24a, 24b and the bridge 26a. The fluid-pressure pipe 32 serves as a passage for introducing a fluid pressure (hydraulic pressure), which is supplied from a master cylinder or the like (not shown) on a vehicle body, via an inlet 32a at one end of the fluid-pressure pipe 32, into the cylinder bores 28a, 28b, 28c as a back pressure on the pistons 18a, 18b, 18c. The other end of the fluid-pressure pipe 32, which is remote from the inlet 32a, is closed by a seal cap 32b.

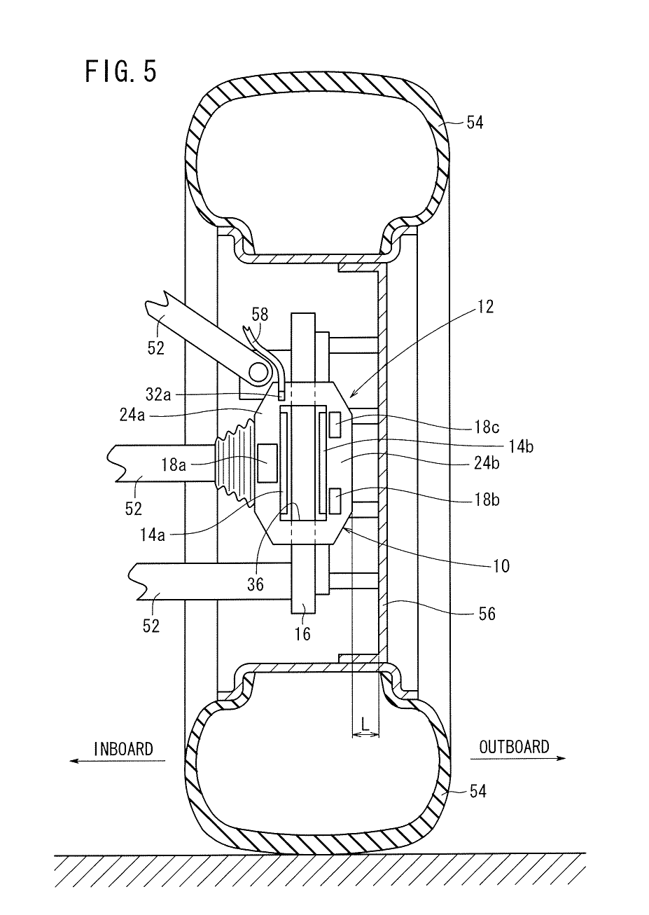

As shown in FIGS. 1 and 2, the brake pads 14a, 14b are disposed in an opening 36 defined centrally in the caliper body 10, and which is surrounded by the acting portions 24a, 24b and the bridges 26a, 26b. The disc rotor 16 is partially inserted into the opening 36 (see FIG. 5).

The brake pads 14a, 14b are fixed to the caliper body 10 by a pair of pins 40 that extend through two pairs of mount holes 38a, 38b defined in the respective acting portions 24a, 24b, and through two pairs of mount holes 42a, 42b defined in the brake pads 14a, 14b. The mount holes 38a, which are juxtaposed in an upper part of the acting portion 24a as shown in FIG. 2, are held in coaxial alignment with the mount holes 38b, which are juxtaposed in an upper part of the acting portion 24b as shown in FIG. 2. The mount holes 42a, 42b also are juxtaposed in respective upper portions of the brake pads 14a, 14b. The brake pads 14a, 14b are supported in the opening 36 by a retainer (pad holder) 44 in the form of a leaf spring, which is interposed between the upper portions of the brake pads 14a, 14b and the pins 40.

One of the brake pads 14a is disposed on an inner surface of the acting portion 24a so as to be pressed by the larger-diameter piston 18a, whereas the other brake pad 14b is disposed on an inner surface of the acting portion 24b so as to be pressed by the smaller-diameter pistons 18b, 18c. When the brake pad 14a is pressed by the larger-diameter piston 18a, and the brake pad 14b is pressed by the smaller-diameter pistons 18b, 18c, the brake pads 14a, 14b are pressed against the disc rotor 16, thereby producing frictional forces that apply braking forces to the motor vehicle.

The area of the acting surface (pressing surface) of the larger-diameter piston 18a is identical or substantially identical to the total area of the acting surfaces (pressing surfaces) of the smaller-diameter pistons 18b, 18c. Stated otherwise, the cross-sectional area of the cylinder bore 28a is identical or substantially identical to the total cross-sectional area of the cylinder bores 28b, 28c. In the present embodiment, the diameter of the piston 18a is set to about 57 mm, and the diameter of the pistons 18b, 18c is set to about 40 mm.

FIG. 4 is a cross-sectional view showing, by way of example, a process of manufacturing the opposed-piston caliper body 10 shown in FIG. 1. More specifically, FIG. 4 schematically shows a process of casting the caliper body 10.

As shown in FIG. 4, the caliper body 10 is integrally cast with a die assembly, in which the die assembly comprises a first die 46, which forms the acting portion 24a and portions of the bridges 26a, 26b from upper to lower surfaces thereof, a second die 48, which forms the acting portion 24b and portions of the bridges 26a, 26b from upper to lower surfaces thereof, and a third die (upper die) 50 disposed on upper surfaces of the first die 46 and the second die 48. The first die 46 includes a pair of cylindrical die members 46a, 46b, which form the smaller-diameter through holes 30b, 30c and the smaller-diameter cylinder bores 28b, 28c. The cylindrical die members 46a, 46b are juxtaposed and project toward the second die 48. Similarly, the second die 48 includes a cylindrical die member 48b, which forms the larger-diameter through hole 30a and the larger-diameter cylinder bore 28a. The cylindrical die member 48b projects toward the first die 46.

When a molten material such as aluminum, for example, is poured into a cavity jointly defined by the first die 46, the second die 48, and the third die 50, the caliper body 10, including the cylinder bores 28a, 28b, 28c and the through holes 30a, 30b, 30c, is cast at once. After the caliper body 10 has been cast, the third die 50 is displaced away from the first die 46 and the second die 48, and then the first die 46 and the second die 48 are displaced away from each other, thereby allowing the caliper body 10 to be removed from the die assembly.

When the caliper body 10 is cast, the fluid-pressure pipe 32, which as shown in FIG. 3 is shaped to hold the cylinder bores 28a, 28b, 28c in fluid communication with each other, is placed in the cavity before the molten material is poured into the cavity. Consequently, the caliper body 10 with the fluid-pressure pipe 32 included therein can easily be formed.

The fluid-pressure pipe 32 should be made of a material having a melting point that is higher than the melting point of the material of the caliper body 10 itself. Therefore, when the molten material is poured into the cavity, the fluid-pressure pipe 32 is prevented from being melted by the material poured into the cavity, and hence the fluid-pressure pipe 32 is reliably placed in the caliper body 10 with the desired shape. For example, the fluid-pressure pipe 32 may be made of iron, which has a melting point of about 1535° C., and the caliper body 10 itself may be made of aluminum, which has a melting point of about 660° C.

The cylinder bores 28a, 28b, 28c, in which the pistons 18a, 18b, 18c are slidably inserted, must be formed with a desired level of mechanical accuracy. To achieve the desired level of mechanical accuracy, after casting thereof, the cast caliper body 10 is machined by a cutting tool such as an end mill, for example. At this time, the cylinder bores 28a, 28b, 28c can easily be cut by the cutting tool, since the tool can be inserted via the through holes 30a, 30b, 30c that are defined coaxially with the cylinder bores 28a, 28b, 28c. At the same time that the cylinder bores 28a, 28b, 28c are cut by the tool, or separately from cutting of the cylinder bores 28a, 28b, 28c, portions of the fluid-pressure pipe 32 are cut off in order to place the cylinder bores 28a, 28b, 28c in fluid communication with the fluid-pressure pipe 32.

With the opposed-piston caliper body 10 according to the present embodiment, as described above, the cylinder bores 28a, 28b, 28c have respective axes that are maintained out of alignment with each other. Further, the through holes 30a, 30b, 30c are defined in the acting portions 24a, 24b in confronting relation to the cylinder bores 28a, 28b, 28c. When the caliper body 10 is cast, the cylindrical die members 46a, 46b, 48a for forming the cylinder bores 28a, 28b, 28c are positioned such that the cylindrical die members 46a, 46b, 48a also will form the through holes 30a, 30b, 30c. Therefore, the caliper body 10 does not need to be made of two separate body members, and hence the caliper body 10 does not require bolts for joining separate body members together. Consequently, the number of parts required to make up the caliper body 10 is reduced. Since it is not necessary to carry out a process for joining together separate body members, the caliper body 10 can be manufactured with increased efficiency. Rather than forming the cylinder bores 28a, 28b, 28c and the through holes 30a, 30b, 30c with the cylindrical die members 46a, 46b, 48c, the caliper body 10 may be cast using a die assembly that is free of the cylindrical die members 46a, 46b, 48c, and thereafter, the cylinder bores 28a, 28b, 28c and the through holes 30a, 30b, 30c may be bored in the caliper body 10.

The cylinder bores 28a, 28b, 28c defined in the caliper body 10 can easily be cut by means of a cutting tool, which is inserted via the through holes 30a, 30b, 30c. When a general floating-type (collet type) brake caliper, which heretofore has been widely used, is manufactured, the cylinder bores are cut by a cutting tool, which is inserted through a gap defined between a pair of fingers on the acting portion that presses the brake pad, under reactive forces exerted when the piston on the other acting portion is actuated. Therefore, the process of cutting the cylinder bores in such a floating-type (collet type) brake caliper is similar to the process of cutting the cylinder bores 28a, 28b, 28c defined in the caliper body 10 according to the present embodiment. In other words, the caliper body 10 according to the present embodiment is advantageous, in that the caliper body 10 can be manufactured using an apparatus, which typically is used for manufacturing floating-type (collet type) brake calipers.

Furthermore, the pistons 18a, 18b, 18c can be inserted into the cylinder bores 28a, 28b, 28c via the through holes 30a, 30b, 30c (see FIG. 2). Since the pistons 18a, 18b, 18c do not need to be inserted into the cylinder bores 28a, 28b, 28c through the central opening (opening 36) in the caliper body 10, unlike the related art, the pistons 18a, 18b, 18c can be assembled in place efficiently. The through holes 30a, 30b, 30c also function as holes that make the caliper body 10 lightweight, and also serve to radiate heat. After the pistons 18a, 18b, 18c are assembled in place, the through holes 30a, 30b, 30c may be closed by lids (not shown).

The number of cylinder bores in one of the acting portions 24a, 24b is different from the number of cylinder bores in the other acting portion. The total cross-sectional area of the cylinder bore 28a in the acting portion 24a is identical or substantially identical to the total cross-sectional area of the cylinder bore 28b, 28c in the acting portion 24b. Therefore, the brake caliper 12 including the caliper body 10 allows the brake pads 14a, 14bto be pressed in a balanced manner by the pistons 18a, 18b, 18c, for thereby improving braking capability. In the illustrated embodiment, one cylinder bore is defined in one of the acting portions, and two cylinder bores are defined in the other acting portion. However, a different number of cylinder bores may be defined in each of the acting portions, insofar as an odd number of cylinder bores is defined in one of the acting portions, whereas an even number of cylinder bores is defined in the other acting portion, so that through holes can be defined in the acting portions in confronting relation to the cylinder bores.

Opposed-piston caliper bodies according to the related art, each of which is made up of two separate caliper body members, require that joints be provided in a fluid-pressure passage, which holds the cylinder bores in fluid communication with each other. Such joints must be combined with seals in order to prevent fluid from leaking out. However, the caliper body 10 according to the present embodiment is integrally formed, while at the same time, the fluid-pressure pipe 32 is embedded in the caliper body 10. Since a fluid-pressure passage is not machined in the caliper body 10 after formation thereof, the caliper body 10 can be manufactured highly efficiently. The caliper body 10 is simple in structure as well as highly reliable and durable, since seals are not required in combination with the fluid-pressure pipe 32.

FIG. 5 is a fragmentary elevational view, partially in cross section, showing vehicle components 52 combined with the brake caliper 12, which incorporates therein the opposed-piston caliper body 10 shown in FIG. 1.

As shown in FIG. 5, the disc rotor 16 is rotatably supported on the vehicle components 52 (such as an upper arm, a lower arm, a constant-velocity joint, etc.). A wheel 56 with a tire 54 mounted thereon is fastened to the disc rotor 16 by bolts. The brake caliper 12 is installed together with the acting portions 24a, 24b, the acting portions 24a, 24b being disposed one on each side of the disc rotor 16.

According to the present embodiment, the acting portion 24b that houses the smaller-diameter pistons 18b, 18c therein is positioned as an outboard acting portion, whereas the acting portion 24a that houses the larger-diameter piston 18a therein is positioned as an inboard acting portion. Stated otherwise, the acting portion 24b with the smaller-diameter pistons 18b, 18c, which tend to be relatively short axially, i.e., in the transverse direction of the motor vehicle, is positioned as an outboard acting portion, while the acting portion 24a with the larger-diameter piston 18a, which tends to be relatively long axially, is positioned as an inboard acting portion.

Therefore, even if the motor vehicle or the wheel 56 is of a type in which the distance (gap) L between the caliper body 10 and the wheel 56 is small, the brake caliper 12 can be installed without causing physical interference between the acting portion 24b and the wheel 56. The brake caliper 12 thus is highly versatile and easy to assemble. The inlet 32a of the fluid-pressure pipe 32, which is coupled to a fluid-pressure passage 58 that extends from the master cylinder or the like (not shown), is disposed in the acting portion 24a having the larger-diameter piston 18a housed therein (see also FIGS. 2 and 3). Accordingly, the fluid-pressure passage 58 from the vehicle body can easily be connected to the inlet 32a.

Although a certain preferred embodiment of the present invention has been shown and described in detail, it should be understood that various changes and modifications may be made to the embodiment without departing from the scope of the invention as set forth in the appended claims.

What is claimed is:

1. An opposed-piston caliper body comprising:
a pair of acting portions adapted to be disposed one on each side of a disc rotor, each of the acting portions having at least one cylinder bore defined therein, and a piston slidably inserted in the at least one cylinder bore; and
a bridge interconnecting the acting portions,
wherein the cylinder bores defined in the acting portions are disposed out of axial alignment with each other, and
one of the acting portions has a through hole defined therein in confronting relation to the cylinder bore defined in another of the acting portions.

2. An opposed-piston caliper body according to claim 1, wherein numbers of the cylinder bores defined in the acting portions are different from each other, and a total cross-sectional area of the at least one cylinder bore defined in one of the acting portions is identical to a total cross-sectional area of the at least one cylinder bore defined in the other of the acting portions.

3. An opposed-piston caliper body according to claim 1, further comprising:
a fluid-pressure pipe holding the cylinder bores in fluid communication with each other, the fluid pressure pipe being integrally embedded in the acting portions and the bridge when the acting portions and the bridge are cast.

4. An opposed-piston caliper body according to claim 2, wherein the at least one cylinder bore defined in the one of the acting portions is greater in diameter than the at least one cylinder bore defined in the other of the acting portions, and the one of the acting portions is positioned as an inboard acting portion.

5. An opposed-piston caliper body according to claim 3, wherein the fluid-pressure pipe has an inlet disposed in one of the acting portions, which is positioned as an inboard acting portion.
